(19) United States
(12) Patent Application Publication
(10) Pub. No.: US 2025/0252852 A1
(43) Pub. Date: Aug. 7, 2025

(54) METHOD FOR TRANSFER LEARNING FOR OPTIMIZING TRAFFIC SIGNAL AND APPARATUS FOR THE SAME

(71) Applicant: ELECTRONICS AND TELECOMMUNICATIONS RESEARCH INSTITUTE, Daejeon (KR)

(72) Inventors: Yong Jin LEE, Daejeon (KR); Moon Young CHUNG, Daejeon (KR)

(21) Appl. No.: 18/918,861

(22) Filed: Oct. 17, 2024

(30) Foreign Application Priority Data
Feb. 7, 2024 (KR) 10-2024-0018522

(51) Int. Cl. G08G 1/08; G06N 20/00; G08G 1/00; G08G 1/01; G08G 1/052

(52) U.S. Cl. CPC G08G 1/08; G06N 20/00; G08G 1/0116; G08G 1/0125; G08G 1/052; G08G 1/20

(57) ABSTRACT

A method and device for a transfer learning for traffic signal optimization are provided. The method may include converting first dynamic traffic information extracted based on a first type of state information corresponding to a first intersection type, and second dynamic traffic information extracted based on a second type of state information corresponding to a second intersection type into a common format; extracting at least one static characteristic information corresponding to at least one of the first intersection type or the second intersection type based on context information; based on the first and second dynamic traffic information and the at least one static characteristic information, outputting a first and second type of action information for an optimized traffic signal for the first and second intersection type, respectively.

### CROSS-REFERENCE TO RELATED APPLICATION(S)

This application claims the benefit of earlier filing date and right of priority to Korean Application No. 10-2024-0018522, filed on Feb. 7, 2024, the contents of which are all hereby incorporated by reference herein in their entirety.

### BACKGROUND

### 1. Technical Field

The present disclosure relates to traffic signal optimization, and more particularly, relates to a transfer learning method for traffic signal optimization and a device therefor.

### 2. Description of Related Art

In order to optimize traffic signals, various factors and variables such as a road structure, road conditions, the state of vehicles on the road, traffic volume, a time zone, etc. must be considered. The existing traffic signal control in a fixed-time control method based on statistical data makes it difficult to dynamically reflect changing traffic conditions. Technologies that apply deep reinforcement learning are being developed to dynamically control traffic signals by reflecting current traffic conditions.

When deep reinforcement learning is applied to traffic signal control, there is a limit in dynamically controlling optimized traffic signals due to the low accuracy of a simulation model, time-consuming learning, etc. In order to overcome this, applying transfer learning using a pre-learned model in similar data or domain to traffic signal optimization is being discussed.

However, when a transfer learning method applied to the existing image processing field, etc. is applied to traffic signal optimization, there is a problem that it is difficult to determine the same or similar pre-learning model because there are a variety of physical specifications such as a road structure, etc.

### SUMMARY

The present disclosure is to provide a transfer learning method for traffic signal optimization and a device therefor.

The present disclosure is to provide a method and a device for configuring and learning a neural network model that may be commonly applied even when a dimension and a shape of input and output according to a variety of road environments are different.

The present disclosure is to provide a method and a device for automatically and quickly finding an optimal pre-learning model for transfer learning for traffic signal optimization or automatically configuring a pre-learning model when there is no pre-learning model.

The technical objects to be achieved by the present disclosure are not limited to the above-described technical objects, and other technical objects which are not described herein will be clearly understood by those skilled in the pertinent art from the following description.

A pre-learning method for traffic signal optimization according to an embodiment of the present disclosure may include converting first dynamic traffic information extracted based on a first type of state information corresponding to a first intersection type, and second dynamic traffic information extracted based on a second type of state information corresponding to a second intersection type into a common format; extracting at least one static characteristic information corresponding to at least one of the first intersection type or the second intersection type based on context information; based on the first dynamic traffic information and the at least one static characteristic information, outputting a first type of action information for an optimized traffic signal for the first intersection type; and based on the second dynamic traffic information and the at least one static characteristic information, outputting a second type of action information for an optimized traffic signal for the second intersection type.

A device for performing pre-learning for traffic signal optimization according to an additional embodiment of the present disclosure may include at least one transceiver; at least one processor; and at least one memory operably connected to the at least one processor and storing an instruction to make the device perform an operation when being executed by the at least one processor. The processor may be configured to convert first dynamic traffic information extracted based on a first type of state information corresponding to a first intersection type input through the at least one transceiver, and second dynamic traffic information extracted based on a second type of state information corresponding to a second intersection type input through the at least one transceiver into a common format; extract at least one static characteristic information corresponding to at least one of the first intersection type or the second intersection type based on context information input through the at least one transceiver; based on the first dynamic traffic information and the at least one static characteristic information, output, through the at least one transceiver, a first type of action information for an optimized traffic signal for the first intersection type; and based on the second dynamic traffic information and the at least one static characteristic information, output, through the at least one transceiver, a second type of action information for an optimized traffic signal for the second intersection type.

In some embodiments of the present disclosure, a dimension of the first type of state information and a dimension of the second type of state information may be different.

In some embodiments of the present disclosure, a dimension of the first dynamic traffic information and the second dynamic traffic information converted into the common format may be the same.

In some embodiments of the present disclosure, the state information may be defined as a vector of a length which is based on a combination of state information elements.

In some embodiments of the present disclosure, the state information elements may include at least one of the number of intersection lanes, the number of vehicles, the speed or the state of a traffic light.

The context information element may include at least one of a layout of an intersection, a position of a traffic light or a road configuration.

In some embodiments of the present disclosure, first static characteristic information for the first intersection type and second static characteristic information for the second intersection type may be different information having the same format.

In some embodiments of the present disclosure, first static characteristic information for the first intersection type and second static characteristic information for the second intersection type may be the same information.

An output dimension of the first type of action information and an output dimension of the second type of action information may be the same.

In some embodiments of the present disclosure, a dimension of a first action generated based on the first type of action information and a dimension of a second action generated based on the second type of action information may be different.

In some embodiments of the present disclosure, the first action may include a time distribution ratio for a first number of signal indications of the first intersection type, and the second action may include a time distribution ratio for a second number of signal indications of the second intersection type.

In some embodiments of the present disclosure, based on backpropagation of a first action generated in response to the first type of action information, a parameter of at least one of a first type of action output layer, a first type of action decoder block, a processing module, a context module, a first type of encoder block or a first type of state input layer may be updated. In addition, based on backpropagation of a second action generated in response to the second type of action information, a parameter of at least one of a second type of action output layer, a second type of action decoder block, the processing module, the context module, a second type of encoder block or a second type of state input layer may be updated.

A transfer learning method for traffic signal optimization according to an additional embodiment of the present disclosure may include obtaining a transfer learning model associated with one type of state information and one type of action information based on at least one pre-learning model associated with a plurality of types of state information and a plurality of types of action information; extracting one dynamic traffic information based on the one type of state information corresponding to one intersection type; extracting one static characteristic information corresponding to the one intersection type based on context information; and outputting one action information for an optimized traffic signal for the one intersection type based on the one dynamic traffic information and the one static characteristic information.

A device for performing transfer learning for traffic signal optimization according to an additional embodiment of the present disclosure may include at least one transceiver; at least one processor; and at least one memory operably connected to the at least one processor and storing an instruction to make the device perform an operation when being executed by the at least one processor. The processor may be configured to obtain a transfer learning model associated with one type of state information and one type of action information based on at least one pre-learning model associated with a plurality of types of state information and a plurality of types of action information; extract one dynamic traffic information based on the one type of state information corresponding to one intersection type input through the at least one transceiver; extract one static characteristic information corresponding to the one intersection type based on context information input through the at least one transceiver; and based on the one dynamic traffic information and the one static characteristic information, output, through the at least one transceiver, one action information for an optimized traffic signal for the one intersection type.

In some embodiments of the present disclosure, the one type of state information associated with the transfer learning model may or may not be included in the plurality of types of state information associated with the at least one pre-learning model. In addition, the one type of action information associated with the transfer learning model may or may not be included in the plurality of types of action information associated with the at least one pre-learning model.

In some embodiments of the present disclosure, based on backpropagation of an action generated in response to the one type of action information, a parameter of at least one of one type of action output layer, one type of action decoder block, one type of encoder block or one type of state input layer may be updated.

In some embodiments of the present disclosure, the transfer learning model may correspond to one pre-learning model learned based on a set of pre-learning environments having a characteristic corresponding to a transfer learning environment among the at least one pre-learning model.

In some embodiments of the present disclosure, when a pre-learning model learned based on a set of pre-learning environments having a characteristic corresponding to a transfer learning environment among the at least one pre-learning model is not included, the transfer learning model may be obtained through pre-learning based on a new set of pre-learning environments.

In some embodiments of the present disclosure, the new set of pre-learning environments may be included in one cluster selected based on a context vector of the transfer learning environment among a plurality of pre-learning environment clusters.

The features briefly summarized above for the present disclosure are just an exemplary aspect of the detailed description of the present disclosure described below, and do not limit the scope of the present disclosure.

According to the present disclosure, a transfer learning method for traffic signal optimization and a device therefor may be provided.

According to the present disclosure, a method and a device for configuring and learning a neural network model that may be commonly applied even when a dimension and a shape of input and output according to a variety of road environments are different may be provided.

According to the present disclosure, a method and a device for automatically and quickly finding an optimal pre-learning model for transfer learning for traffic signal optimization or automatically configuring a pre-learning model when there is no pre-learning model may be provided.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a diagram for describing an agent and an environment according to the present disclosure.

FIG. 2 is a diagram for describing examples of pre-learning and transfer learning according to the present disclosure.

FIG. 3 is a diagram for describing a pre-learning model and a pre-learning method according to the present disclosure.

FIGS. 4 to 7 are diagrams for describing examples of a pre-learning method according to the present disclosure.

FIGS. 8 to 10 are diagrams for describing examples of a transfer learning model and a transfer learning method according to the present disclosure.

FIGS. 11 and 12 are diagrams for describing examples of a transfer learning method according to the present disclosure.

FIG. 13 is a diagram for describing an example for obtaining a transfer learning model according to the present disclosure.

FIG. 14 is a diagram for describing an additional example of obtaining a transfer learning model according to the present disclosure.

FIGS. 15 to 18 are diagrams for describing examples for configuring a set of pre-learning environments according to the present disclosure.

FIG. 19 is a diagram for describing an example of a pre-learning method for traffic signal optimization according to the present disclosure.

FIG. 20 is a diagram for describing an example of a transfer learning method for traffic signal optimization according to the present disclosure.

FIG. 21 is a block diagram of a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

A term used in the present disclosure is defined as follows.

Machine learning is a technology that provides information such as prediction/classification/pattern analysis, etc. through data-based learning and inference based on a given purpose.

As reinforcement learning is a subfield of machine learning, unlike supervised learning that output for input (e.g., a target or a label) is clearly given, it is a learning method through trial and error using a reward, which is a short-term evaluation scale for an agent's action, as feedback. Instead of selecting an action with a large short-term reward value that may be obtained immediately, an agent is learned to take an action that maximizes the sum of reward values (e.g., a state value, or a state-action value, etc.) in the long term.

As a deep neural network is a subfield of machine learning, it is a machine learning model or algorithm that imitates the neural network of living organisms. Deep neural networks consist of a nested structure of nonlinear functions expressed in layers. Multiple layers may be created to configure an arbitrary nonlinear function.

As deep reinforcement learning is a learning method that combines a deep neural network technology with a conventional reinforcement learning technology, its distinguishing feature from a conventional reinforcement learning technology is that it uses a deep neural network as an agent model.

As transfer learning is a technique used when there is little learning data, it is a method for reusing a pre-learned model by using a large amount of similar data.

As traffic signal optimization is a process of optimizing traffic flow by improving a traffic signal system, it may reduce traffic congestion and improve vehicle movement speed and efficiency.

Specifically, an existing method for applying deep reinforcement learning to traffic signal optimization has a problem as follows in terms of simulation model accuracy and learning time.

In order to perform signal optimization through deep reinforcement learning, a simulation model that imitates the real environment is required. However, for a newly constructed road and intersection, it is difficult to collect sufficient data to create an accurate simulation model from the beginning. It may avoid creating a simulation model or reduce the accuracy of a simulation model, and accordingly, it may be difficult to learn an optimal traffic signal.

In addition, since deep reinforcement learning is based on trial and error, deep reinforcement learning for traffic signal optimization inevitably takes a long time to learn. In particular, a changed road condition or a new road condition may require relearning from the beginning.

In order to overcome this limit on deep reinforcement learning, the use of a transfer learning technique that utilizes a model pre-trained in similar data or domain is being discussed. For example, in an image processing field, a transfer learning technique that brings a pre-trained neural network with a large image data set and applies it to a new task is widely used. These success cases show a possibility that transfer learning may solve the problem of data shortage and provide high performance. In addition, since it utilizes a pre-learned model, it is not necessary to newly learn from the beginning, which may reduce time and resources required to learn according to new data.

It may be difficult to apply a transfer learning technique applied to an image processing field to traffic signal optimization. For example, considering that a road shape and a signal indication are different at each intersection, it is difficult to directly apply a transfer learning method used in an image processing field to traffic signal optimization. Although an image is enlarged or reduced, the content within an image itself is not damaged. As an example, even if a picture of a dog is reduced or enlarged, a picture of a dog is not changed into a picture of a cat. In addition, for a convolution operation of a convolution neural network (CNN) mainly used in an image field, since it extracts a local characteristic, a structure of a deep neural network and a weight of a convolution operation learned in an input image of a different size may be used as they are. In addition, it is not a big problem even if a position and order that a main characteristic appears within an input image are different. As an example, even if a cat exists at a different position in an image, the meaning itself that a cat exists in a corresponding image may not be changed. Meanwhile, for traffic signal optimization, an input size is directly related to a physical standard and characteristic such as the number of lanes of a road connected to an intersection. Accordingly, when an input size is different or when the order of input data is different even if an input size is the same, the meaning of an input value should be interpreted differently. In other words, in order to use a pre-learning model learned in a certain intersection environment in a different intersection environment, it is required to adjust an input size or structure of a transfer learning model. However, if an input size or structure of a transfer learning model is changed, a physical characteristic of an intersection of a transfer learning model may be arbitrarily changed, which may cause a problem that the meaning of an input value is distorted.

In order to solve this problem, the present disclosure describes various examples of a method for configuring a neural network model that may be commonly applied even when a dimension and a shape of input and output are different (e.g., when a road shape and a signal indication are different for each intersection) and a learning method for a corresponding model.

In addition, for transfer learning in traffic signal optimization based on deep reinforcement learning, it is required to reuse a model pre-learned at a similar intersection (or road environment). However, professional knowledge and lots of time are required to determine a similarity between traffic environments at an intersection by analyzing the characteristic of various intersections and roads, as described above.

In order to solve this problem, the present disclosure describes various examples of a method for automatically finding/selecting an optimal (i.e., most similar) pre-learning model for transfer learning without the intervention of an administrator/a user, and a method for automatically configuring a set of pre-learning environments similar to a transfer learning environment when there is no proper pre-learning model for transfer learning.

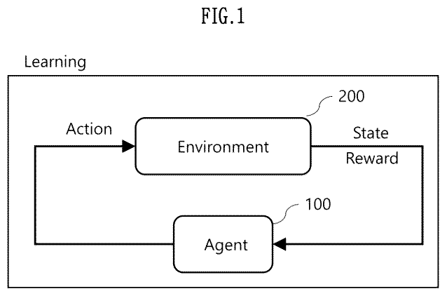

FIG. 1 is a diagram for describing an agent and an environment according to the present disclosure.

In an example of FIG. 1, an agent (100) is an object that performs decision-making as a subject of reinforcement learning. An agent may recognize a specific state while interacting with an environment (200) and select an action that may be taken under a corresponding state. In addition, it may receive a reward for a selected action and acquire an optimal action strategy through learning. For traffic signal optimization, an action of an agent (100) may include the following examples. The following examples do not limit a scope of the present disclosure, and the examples of the present disclosure may also be equally applied to another action or a combination of a plurality of actions.
Signal Cycle Configuration: An agent (100) configures a cycle of a traffic signal. It means the time it takes for a signal to complete one full cycle. For example, when it is configured as 60 seconds, all signals have a cycle that they are changed for 60 seconds.
Signal Timing Adjustment: An agent (100) adjusts timing for a traffic signal. It refers to determining a duration of a color of each signal (e.g., red, yellow, green). An agent (100) optimizes traffic flow by adjusting a transition time point between signals and a duration of a signal.
Lane Signal Manipulation: An agent (100) may also individually manipulate a signal for each lane in a traffic signal system. It may change the priority of a specific lane or adjust the flow of vehicles.

An environment (200) is an object with which an agent (100) interacts, and may represent an external world. An environment (200) provides a transition to a next state (state transition) in response to an action of an agent (100) and grants a reward. In traffic signal optimization, an environment (200) may be a simulation model that models an actual road network and a traffic situation at an intersection and a simulator that operates it. In traffic signal optimization, the state of an environment (200) may include the following examples. The following examples do not limit a scope of the present disclosure, and the examples of the present disclosure may also be equally applied to another state or a combination of a plurality of states.
Traffic Flow: A traffic flow represents the current flow and mobile state of

vehicles in a road network. It may include information regarding the number of vehicles, speed, congestion, etc. at a major intersection, a road section, a lane, etc.
Signal State: A signal state describes the state of a traffic signal system. It may include the color of each signal (e.g., red, yellow, green) and time left until a signal changes.
Traffic Environment Information: Traffic environment information may include other variables and information related to a traffic environment. For example, weather conditions, road conditions (e.g., construction, accidents, etc.), surroundings (e.g., buildings around an intersection, crosswalks, etc.), etc. may be included as state information.

The examples of an index as below may be used as a reward in traffic signal optimization. The following examples do not limit a scope of the present disclosure, and the examples of the present disclosure may also be equally applied to another reward or a combination of a plurality of rewards.
Vehicle Moving Speed: The average moving speed of a vehicle is an important index of traffic efficiency. A high reward may be given when a vehicle moves smoothly and a delay is minimized.
Reduced Waiting Time: Minimizing vehicle waiting time is an important goal for improving traffic efficiency. A reward may be given according to the degree to which a signal is properly adjusted to reduce vehicle waiting time.
Traffic Liquidity: Traffic liquidity means that a vehicle movement and a traffic flow are smooth within a road network. As vehicles move more smoothly and delays at an intersection or a traffic bottleneck point are reduced to minimum, a higher reward may be given.
Average Travel Time: As an average difference between the arrival time and the departure time of a vehicle is reduced to minimum, a higher reward may be given.
Reduced Traffic Delay: A reward may be given when a signal is adjusted optimally to reduce a traffic delay.

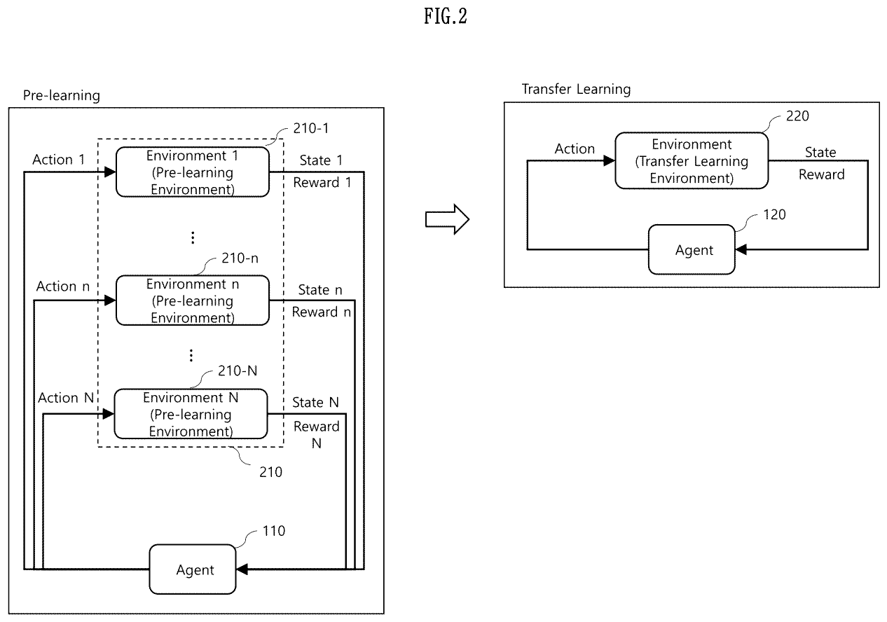

FIG. 2 is a diagram for describing examples of pre-learning and transfer learning according to the present disclosure.

In the present disclosure, a learning process may be divided into a pre-learning step and a transfer learning step. In a pre-learning step, a variety of intersection environments may be used to learn the basic actions and strategies of an agent and in a transfer learning step, this pre-learned model may be applied to a new specific road environment to perform additional learning. It is assumed that a pre-learning environment collects sufficient traffic environment data to accurately configure a simulation model for various intersections.

A pre-learning step is a step for learning a basic action and strategy required for efficient traffic control at an intersection and a traffic situation. An agent (110) has an ability to improve general traffic efficiency by learning about a variety of environments and traffic situations (e.g., N pre-learning environments (210-1, . . . , 210-N)) in a pre-learning environment set (210). A learning model (i.e., a pre-learning model) obtained as a result of a pre-learning step may be reused in a transfer learning step. A method for configuring and a method for learning a deep neural network model of an agent which may even accept that the number and order of indications are different or the number of lanes is different between intersections are described later.

In a transfer learning step, additional learning may be performed by applying a pre-learned agent model (110) to a transfer learning environment. A pre-learned agent model (110) may adapt to a new environment (220) and learn an optimal action through adjustment, obtaining a transfer-learned agent model (120). Transfer learning may reduce a learning time and cost by utilizing the knowledge and experience of a pre-learned model and quickly adapt to a new environment.

As described above, in the present disclosure, a learning environment (200) is divided into a pre-learning environment (210-1, . . . , 210-N) and a transfer learning environment (220).

An individual environment used in a pre-learning step is defined as ‘a pre-learning environment’. In addition, a set including different pre-learning environments (210-1, . . . , 210-N) is defined as ‘a pre-learning environment set (210)’. In order for an agent (110) in a pre-learning step to learn a general action and strategy required to improve traffic efficiency, a pre-learning environment set (210) may be configured to include various intersections and signal configurations.

Intersections corresponding to each individual pre-learning environment (210-1, . . . , 210-N) of a pre-learning environment set (210) do not need to have the same physical standard. For example, each pre-learning environment (210-1, . . . , 210-N) may be different in the number of lanes or the number and order of signal indications. A pre-learning environment set (210) may be configured as a set including a plurality of pre-learning environments (210-1, . . . , 210-N) by considering the diversity and similarity of traffic environments. As an example, when there are five cities, five pre-learning environment sets (210) may be configured. Each pre-learning environment set (210) may be composed of simulation models that imitate an individual pre-learning environment (210-1, . . . , 210-N) corresponding to intersections in a corresponding city. As another example, for a large city, instead of configuring intersections in the entire city as one pre-learning environment set (210), a city may be divided into areas to configure a pre-learning environment set (210). Alternatively, an environment in regions which belong to a different city, but have a similar traffic flow characteristic may be collected to configure one pre-learning environment set (210).

Transfer learning corresponds to a step of configuring an agent model (120) in a transfer learning step by applying an agent model (110) learned in a pre-learning step to a new intersection environment (i.e., a transfer learning environment) and learning it. An environment used in a transfer learning step is defined as a ‘transfer learning environment (220)’. A transfer learning environment (220) may be changed from the existing environment used in pre-learning (210) (e.g., a change in the number of lanes and/or the number of indications) or may correspond to an intersection environment that is completely new to a pre-learning environment (210). An agent (120) may acquire an action that may respond to the variability and diversity of a new road while performing additional learning in a transfer learning environment (220) based on a pre-learned model (210).

A pre-learning model is a deep neural network model of an agent that is learned by using various intersection environments belonging to a pre-learning model set. On the other hand, a transfer learning model is a deep neural network model of an agent that is generated by performing additional learning by applying a pre-learned model to a transfer learning environment.

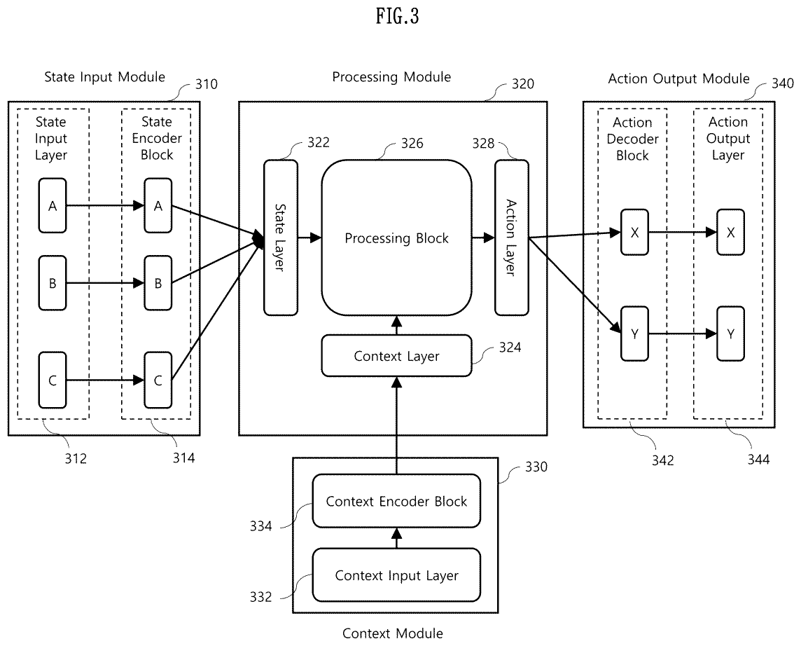

FIG. 3 is a diagram for describing a pre-learning model and a pre-learning method according to the present disclosure.

An example of FIG. 3 corresponds to an example of a deep neural network (e.g., a pre-learning model) of an agent (110) for pre-learning.

In an example of FIG. 3, it is assumed that an intersection belonging to a pre-learning set may be classified into Types A, B and C according to a traffic environment and Types X and Y according to a signal indication. For example, A represents an intersection type consisting of four lanes, B represents an intersection type consisting of five lanes, and C represents an intersection type consisting of three lanes, and X represents an intersection type consisting of four indications and Y represents an intersection type consisting of five indications. For example, Environment (or Intersection) 1 of a pre-learning environment set may have Input Type A and Output Type X. As another example, Environment (or Intersection) 2 of a pre-learning environment set may have Input Type B and Output Type Y. As another example, Environment (or Intersection) 3 of a pre-learning environment set may have Input Type C and Output Type X. As another example, Environment (or Intersection) n of a pre-learning environment set may have Input Type A and Output Type Y.

A deep neural network used as a pre-learning model may include a state input module (310), a processing module (320), a context module (330) and an action output module (340).

A state input module (310) may include a state input layer (312) and a state encoder block (314).

A state input layer (312) may transmit state information to a neural network. A state input layer (312) may digitize the state information and convert it into a format that may be processed by a neural network. State information may include a current situation of a traffic environment and signal information. For example, state information such as the number of vehicles, speed, traffic light conditions, etc. may be input through a state input layer (312). The number (or dimension) of values input in a state input layer (312) may be configured to be proportional to the number of lanes of a corresponding intersection. For example, it is assumed that Input Type A corresponds to a case in which the number of lanes is 4. If the number of vehicles and speed are used as state information, State Input Layer (312) A may be configured to process a total of 8-dimensional input by configuring a pair of (the number of vehicles, speed) for each lane as state information. As another example, if it is assumed that Input Type B corresponds to a case in which the number of lanes is 5 and the number of vehicles and speed are used as state information, State Input Layer (312) B may be configured to process a total of 10-dimensional input. It may also be configured to receive state information calculated in a variety of intersection and road environments by configuring an input size differently for each input layer according to an intersection type.

A state encoder block (314) may convert state information input through a state input layer (312) into a common format that may be processed by a processing module (320). A state encoder block (314) may be configured with at least one layer. A state encoder block (314) may embed given state information, extract necessary traffic situation information and transmit it to a processing module (320). In an example of FIG. 3, a dimension of a value input to each of State Encoder Block A, State Encoder Block B and State Encoder Block C may be different according to a traffic environment type. For a case in which a dimension of an input value is the same or different, a dimension of an output value of State Encoder Block A, State Encoder Block B and State Encoder Block C may be configured to be the same. In other words, a state layer (322) of a processing module (320) may be configured to receive a value of the same dimension from a state input module (310).

A context module (330) may include a context input layer (332) and a context encoder block (334).

A context input layer (332) may transmit context information to a neural network. A context input layer (332) may digitize context information and convert it into format that may be processed by a neural network. Context information may correspond to information that includes a physical characteristic or a traffic environment characteristic of an intersection separate from (or associated with) state information input through a state input layer (312). While state information input through a state input layer (312) represents dynamic information that is changed according to traffic conditions, context information input through a context input layer (332) may represent a static characteristic of an intersection as static information. Context information is fixed information such as a layout of an intersection, a position of traffic lights, a road configuration, etc., and may include a physical characteristic of each intersection.

A context encoder block (334) may convert context information input through a context input layer (332) into a format that may be processed by a processing module (320). A context encoder block (334) may be configured with at least one layer. A context encoder block (334) may embed given context information, extract a static characteristic of an intersection and transmit it to a processing module (320). While the state input layers (312) of the above-described state input module (310) are configured in multiple layers for each dimension of environment state information to receive and process environment information in a different dimension, a context encoder block (334) may be configured to express a static characteristic of a learning environment (or an intersection) in a unified format.

A processing module (320) may process input state information to generate an intermediate representation necessary for a neural network to make a decision. A processing module (320) may include a state layer (322), a context layer (324), a processing block (326) and an action layer (328).

A state layer (322) may convert information output from a state input module (310) into a format that may be processed by a processing block (320).

A context layer (324) may play a role of converting information output from a context module (330) into a format that may be processed by a processing block (320).

A processing block (326) may integrate state information transmitted from a state input module (310) and context information transmitted from a context module (330) and learn a pattern that may select an optimal action at an intersection through learning accordingly. Through this, an effective action may be determined by comprehensively considering a static characteristic of an intersection and a dynamic traffic situation. A processing block (326) may be configured with at least one layer.

An action layer (328) may transmit information processed in a processing block (326) to an action output module (340).

An action output module (340) may receive information processed in a processing module (320) to generate final output. An action output module (340) may include an action decoder block (342) and an action output layer (344).

An action decoder block (342) may convert information processed in a processing block (320) into output for a final action decision more effectively according to each intersection environment. An action decoder block (342) may be configured with at least one layer. An output dimension of an action layer of a processing module (320) and an input dimension of an action decoder block (342) may be configured to be the same. In addition, even if an input dimension of an action decoder block (342) is the same, an output dimension of an action decoder block (342) may be configured differently according to each intersection or pre-learning environment.

An action output layer (344) is the final output of a neural network and may generate an agent's action. For example, when Output Type X corresponds to four indications, Action Output Layer X may be configured to output a time distribution ratio for four indications in a four-dimensional form. As another example, when Output Type Y corresponds to six indications, Action Output Layer Y may be configured to output a time distribution ratio for fix indications in a six-dimensional form.

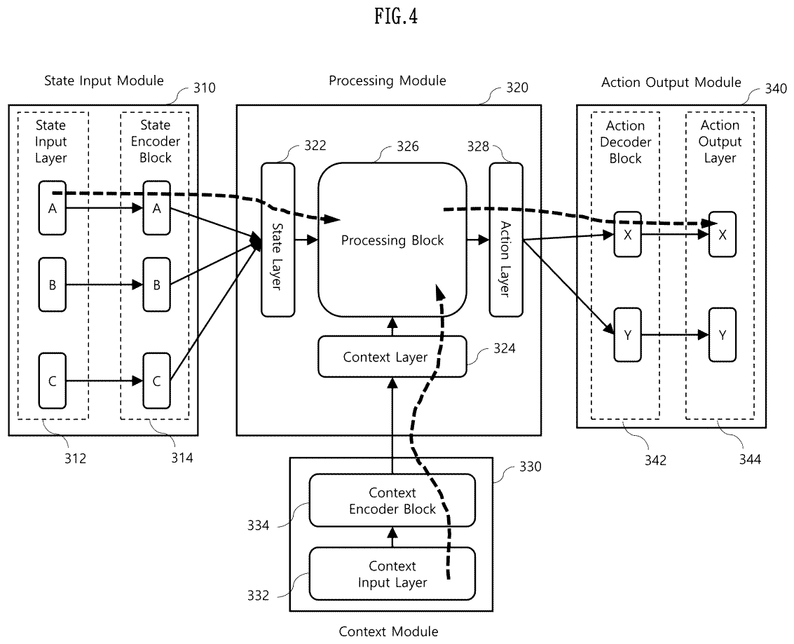

FIGS. 4 to 7 are diagrams for describing examples of a pre-learning method according to the present disclosure.

Referring to FIGS. 4 to 7, a method for training a pre-learning model of a reinforcement learning agent is described.

In an example of FIG. 4, a forward propagation process is described by assuming that the state information and context information of Pre-learning Environment 1 (Input Type A, Output Type X) are input. State information is transmitted to a processing module through State Input Layer A and State Encoder Block A. Context information corresponding to a pre-learning environment is transmitted to a processing module through a context module. A processing module processes information received through a state input module and a context module and transmits it to an action output module. Action Decoder Block X of an action output module processes a value received from a processing module and transmits it to Action Output Layer X.

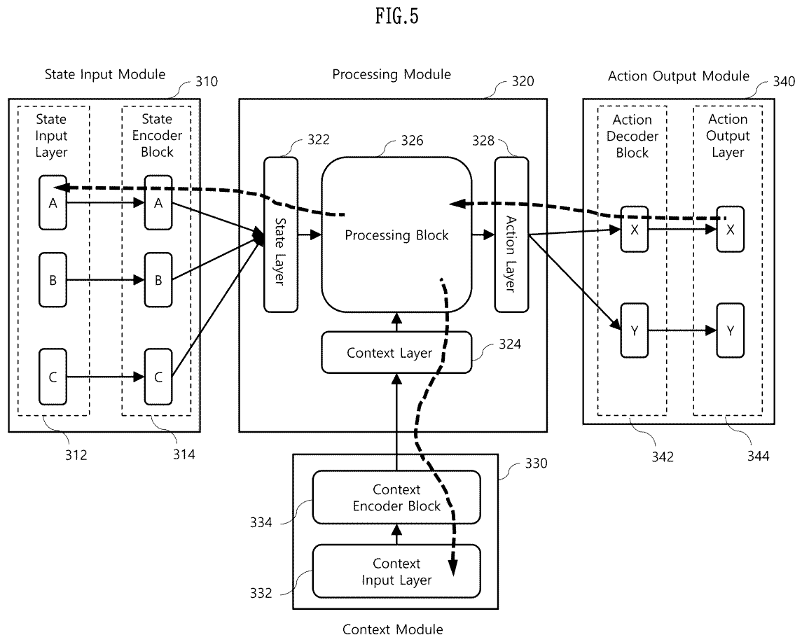

In an example of FIG. 5, a backward propagation process for updating a parameter of a deep neural network in pre-learning is described. Information is transmitted from Action Output Layer X to State Input Layer A and a context module through a processing block. Accordingly, a parameter of Action Output Layer X and Action Decoder Block X and State Input Layer A and State Encoder Block A of a processing module, a context module and a state input module may be updated according to a pre-learning environment. Here, backpropagation information for parameter update may not be transmitted from Action Output Layer X to a block and a layer that get out of a path connecting State Information Input Layer A or a context module.

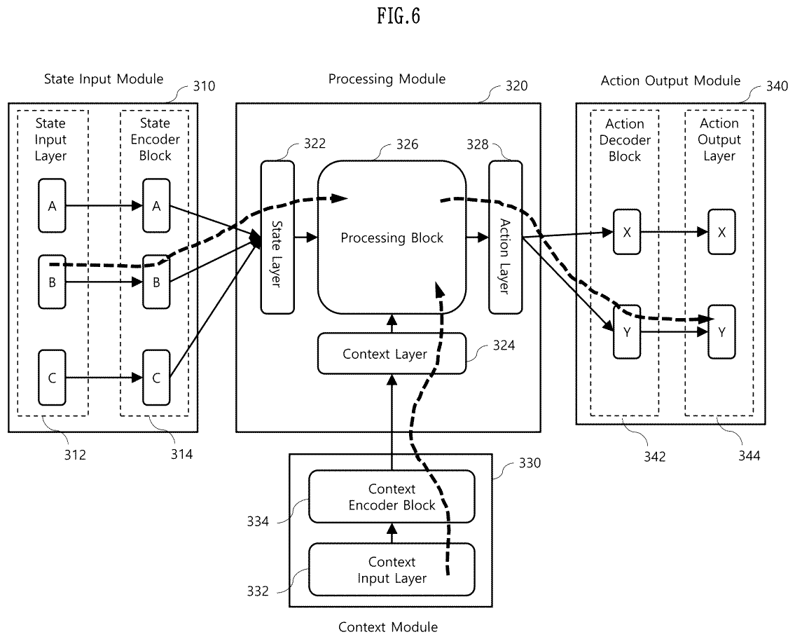

In an example of FIG. 6, a forward propagation process is described by assuming that the state information and context information of Pre-learning Environment 2 (Input Type B, Output Type Y) are input. State information is transmitted to a processing module through State Input Layer B and State Encoder Block B. Context information corresponding to a pre-learning environment is transmitted to a processing module through a context module. A processing module processes information received through a state input module and a context module and transmits it to an action output module. Action Decoder Block Y of an action output module processes a value received from a processing module and transmits it to Action Output Layer Y.

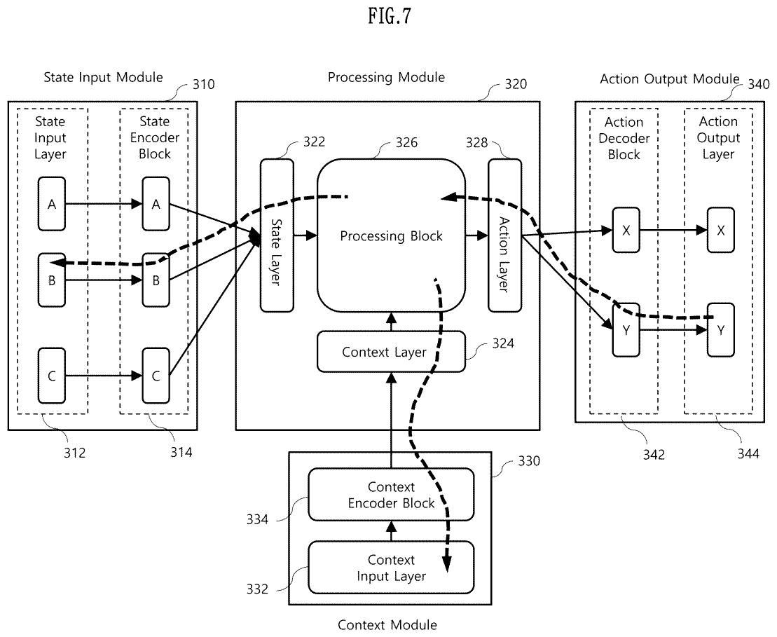

In an example of FIG. 7, a backward propagation process for updating a parameter of a deep neural network in pre-learning is described. Information is transmitted from Action Output Layer Y to State Input Layer B and a context module through a processing block. Accordingly, a parameter of Action Output Layer Y and Action Decoder Block Y and State Input Layer B and State Encoder Block B of a processing module, a context module and a state input module may be updated according to a pre-learning environment. Here, backpropagation information for parameter update may not be transmitted from Action Output Layer Y to a block and a layer that get out of a path connecting State Information Input Layer B or a context module.

As described above, a state input module and an action output module are learned according to an individual pre-learning environment. Meanwhile, a context module and a processing module may have an ability to process information about a general traffic situation by learning about the entire pre-learning environment set.

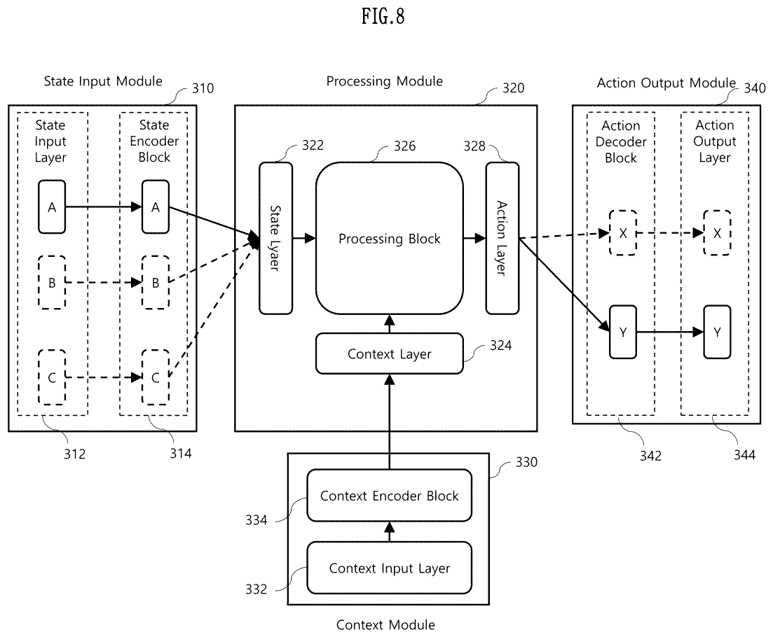

FIGS. 8 to 10 are diagrams for describing examples of a transfer learning model and a transfer learning method according to the present disclosure.

A deep neural network model of an agent for transfer learning may reuse a pre-learning model. For example, if a transfer learning environment has A-type environment state information and Y-type output action information, a transfer learning model as in FIG. 8 may be configured. In other words, only a layer and a block corresponding to a corresponding type in a state input module and an action output module may be selected and used. A processing module and a context module may be reused in the same way as a processing module and a context module of a pre-learning model. Context information for a corresponding transfer learning environment is input to a context module.

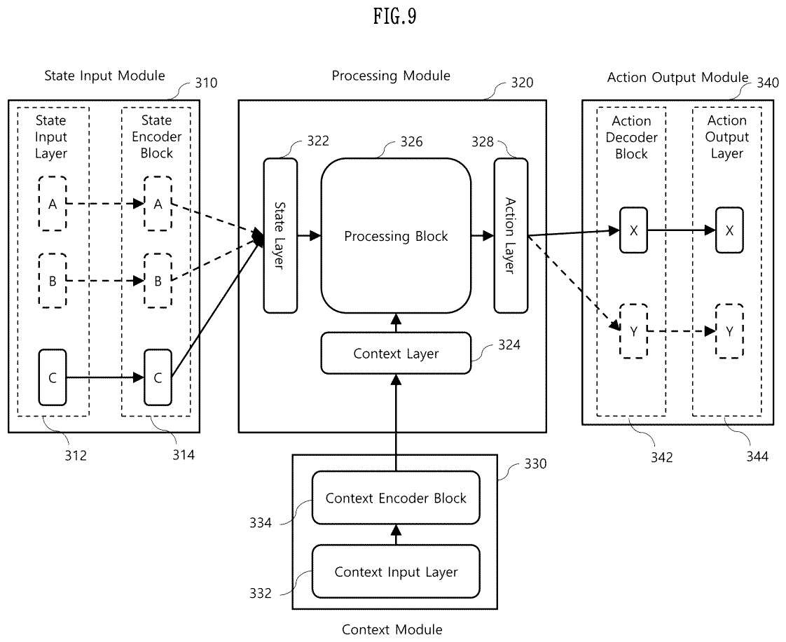

As an additional example, if a transfer learning environment has C-type environment state information and X-type output action information, a transfer learning model as in FIG. 9 may be configured. In other words, only a layer and a block corresponding to a corresponding type in a state input module and an action output module may be selected and used. A processing module and a context module may be reused in the same way as a processing module and a context module of a pre-learning model. Context information for a corresponding transfer learning environment is input to a context module.

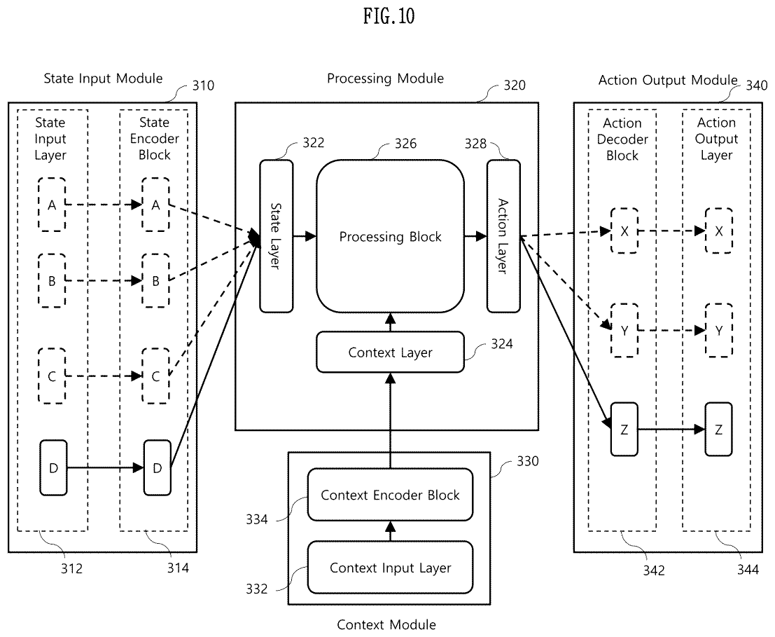

As another example, if a transfer learning environment has a new type (e.g., type D) of environment state information different from a pre-learning environment and a new type (e.g., type Z) of output action information, a transfer learning model as in FIG. 10 may be configured. In other words, a state information type not included in a pre-learning model (e.g., type D) and/or an action information type not included in a pre-learning model (e.g., type Z) may be newly/additionally defined in a transfer learning model. A processing module and a context module may be reused in the same way as a processing module and a context module of a pre-learning model. Context information for a corresponding transfer learning environment is input to a context module.

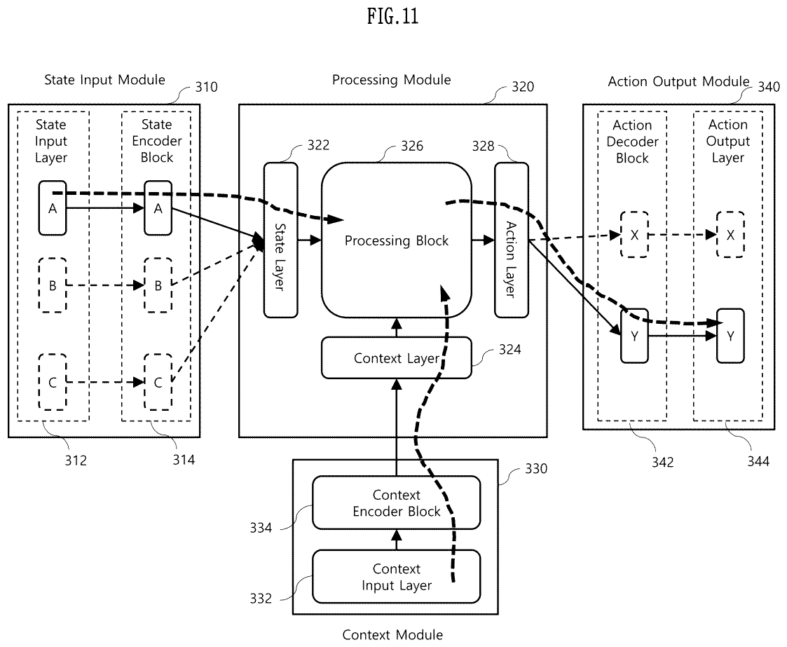

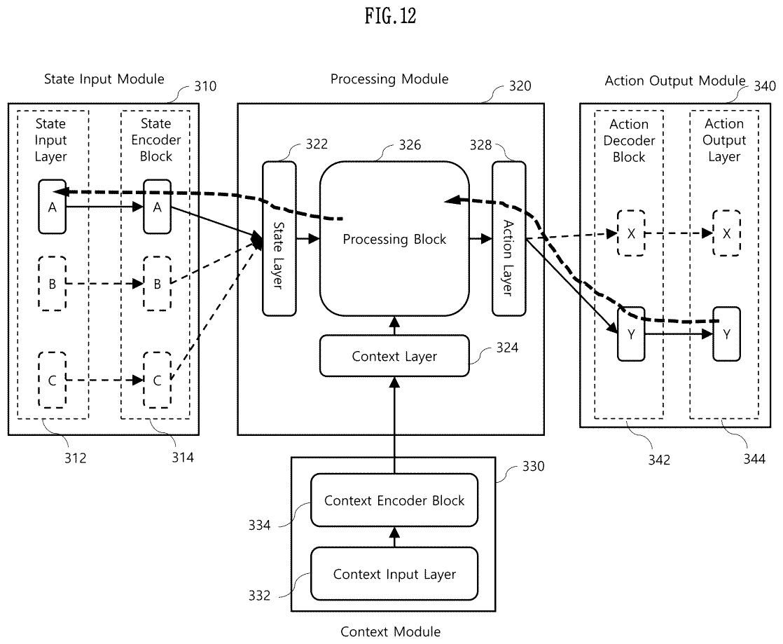

FIGS. 11 and 12 are diagrams for describing examples of a transfer learning method according to the present disclosure.

The examples of FIGS. 11 and 12 correspond to a transfer learning method based on an example of FIG. 8 described above (i.e., an example in which a transfer learning environment is configured based on Environment State Information Type A and Output Action Information Type Y). A scope of the present disclosure is not limited thereto, and as in an example of FIGS. 9 and 10, or for a transfer learning model based on an environment state information type and/or an output action information type that is included or is not included in an environment state information type and/or an output action information type on which a pre-learning model is based, an example of a transfer learning method described by referring to FIGS. 11 and 12 may be applied equally/similarly.

In an example of FIG. 11, if the state information of a transfer learning environment is input to State Input Layer A and the context information of a transfer learning environment is input to a context module, respectively, a value may be forward-propagated to Action Output Layer Y of an action output module through a processing module. For example, state information is transmitted to a processing module through State Input Layer A and State Encoder Block A. Context information corresponding to a transfer learning environment is transmitted to a processing module through a context module. A processing module processes information received through a state input module and a context module and transmits it to an action output module. Action Decoder Block Y of an action output module processes a value received from a processing module and transmits it to Action Output Layer Y.

In an example of FIG. 12, a backpropagation process for updating a parameter of a deep neural network in transfer learning may be performed. A parameter of Action Output Layer Y and Action Decoder Block Y and State Input Layer A and State Encoder Block A of a state input module may be updated according to a transfer learning environment through transmission from Action Output Layer Y to State Input Layer A through a processing block. Accordingly, a state input module and an action output module may be adapted to a new learning environment.

Here, a parameter of a processing module on a path connecting Action Output Layer Y and State Input Layer A may not be updated. Alternatively, a parameter of a processing module on a path connecting Action Output Layer Y and State Input Layer A may be updated based on a learning rate smaller than a learning rate applied to a state input module or an action output module. Accordingly, since a processing module is learned to be universal for various pre-learning environments, it may be prevented from being learned according to one specific transfer learning environment. Similarly, a parameter of a context module may not be updated.

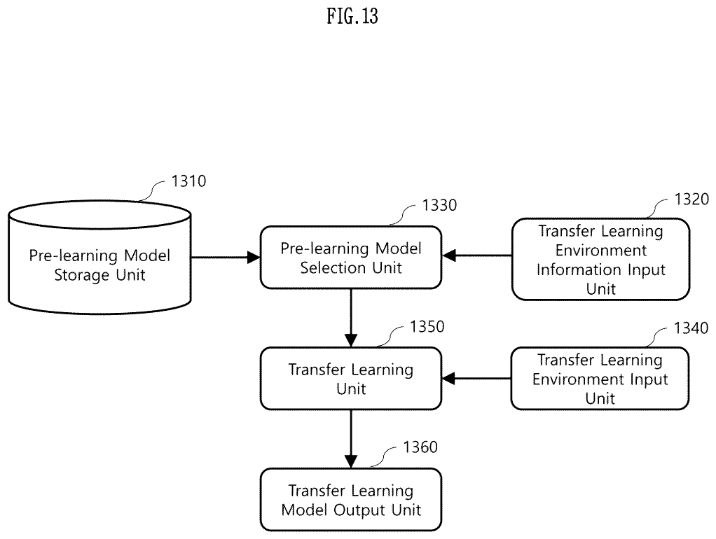

FIG. 13 is a diagram for describing an example for obtaining a transfer learning model according to the present disclosure.

If there is a pre-learning model learned in a pre-learning environment set similar to a transfer learning environment, a transfer learning model may be acquired according to an example like FIG. 13.

A pre-learning model storage unit (1310) may store/maintain/update deep neural network models of an agent learned for each pre-learning environment set. A pre-learning model storage unit (1310) may store information on a characteristic of a traffic environment of a pre-learning environment set together (e.g., in association with a specific deep neural network model). For example, information, etc. on a characteristic of a region (e.g., a commercial district, a residential district), the traffic volume, a season that may affect a traffic environment, etc. for a pre-learning environment set may be stored as information on a characteristic of a traffic environment.

A transfer learning environment information input unit (1320) may input information on a transfer learning environment. For example, information, etc. on a characteristic of a region (e.g., a commercial district, a residential district), the traffic volume, a season that may affect a traffic environment, etc. for a transfer learning environment may be input.

A pre-learning model selection unit (1330) may select a pre-learning model learned based on a pre-learning environment set with a similar characteristic, based on information on a pre-learning environment set and information on a transfer learning environment.

A transfer learning environment input unit (1340) may input a simulation model for transfer learning, i.e., a transfer learning environment.

A transfer learning unit (1350) may perform transfer learning by using a pre-learning model selected in a pre-learning model selection unit (1330) and a transfer learning environment input in a transfer learning environment input unit (1340).

A transfer learning model output unit (1360) may output a model learned in a transfer learning unit (1350) or store it in a designated storage device.

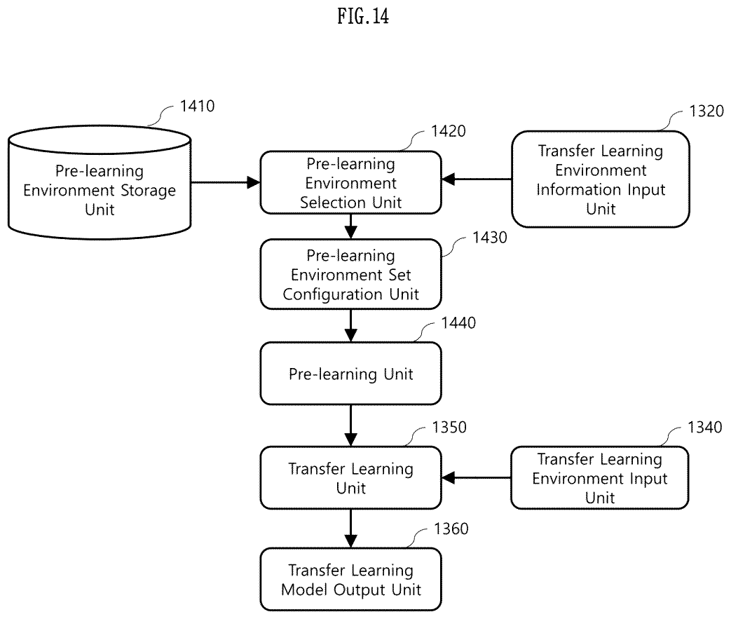

FIG. 14 is a diagram for describing an additional example of obtaining a transfer learning model according to the present disclosure.

When there is no pre-learning model learned in a pre-learning environment set similar to a transfer learning environment, a new pre-learning environment set may be configured from pre-stored pre-learning environments to perform pre-learning and learn by applying it to a transfer learning environment.

A pre-learning environment storage unit (1410) may store/maintain/update environments that may be used for pre-learning. A pre-learning environment storage unit (1410) may store a characteristic of a traffic environment corresponding to a pre-learning environment together (or in association). For example, information on a characteristic of a region (e.g., a commercial district, a residential district), the traffic volume, a season that may affect a traffic environment, etc. for a pre-learning environment may be stored.

A transfer learning environment information input unit (1320) may input information on a transfer learning environment. For example, information, etc. on a characteristic of a region (e.g., a commercial district, a residential district), the traffic volume, a season that may affect a traffic environment, etc. for a transfer learning environment may be input.

A pre-learning environment selection unit (1420) may select a pre-learning environment of a region with a similar characteristic, based on information on a pre-learning environment and information on a transfer learning environment. Multiple pre-learning environments may be selected.

A pre-learning environment configuration unit (1430) may configure a pre-learning environment model set by collecting environment models selected in a pre-learning environment selection unit.

A pre-learning unit (1440) may perform pre-learning by using a pre-learning environment set configured in a pre-learning environment set configuration unit.

A transfer learning environment input unit (1340) may input a simulation model for transfer learning, i.e., a transfer learning environment.

A transfer learning unit (1350) may perform transfer learning by using a transfer learning environment input in a transfer learning environment input unit (1340) and a pre-learning model learned in a pre-learning unit (1440) (not a pre-learning model selected in a pre-learning model selection unit (1330) in an example of FIG. 13 because it relates to a case in which there is no pre-learning model in an example of FIG. 14).

A transfer learning model output unit (1360) may output a model learned in a transfer learning unit (1350) or store it in a designated storage device.

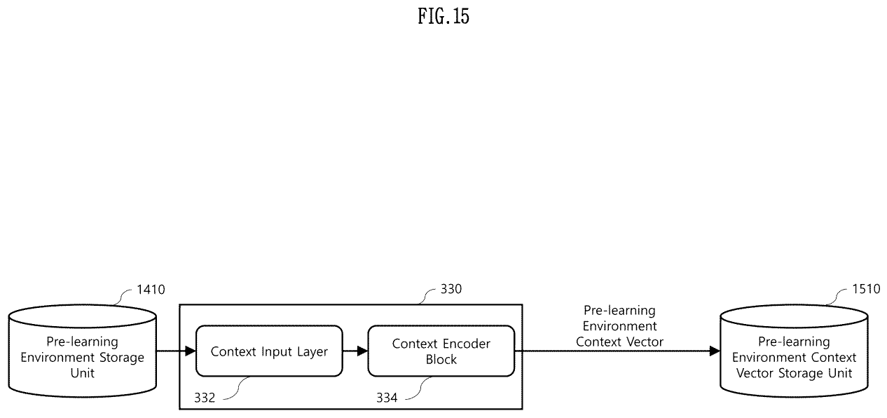

FIGS. 15 to 18 are diagrams for describing examples for configuring a set of pre-learning environments according to the present disclosure.

A context vector which is the output of a context module (330) included in a pre-learning model may be used to select a pre-learning environment similar to a transfer learning environment and configure a pre-learning environment set.

An example of FIG. 15 shows a process of generating a context vector of a pre-learning environment.

A pre-learning environment storage unit (1410) may store/maintain/update a pre-learning environment set as described above.

A context module (330) corresponds to a context module of a pre-learning model learned by using a learning environment set stored in a pre-learning environment storage unit (1410), and may include a context input layer (332) and a context encoder block (334). When the context information of a pre-learning environment is input to a context module (330), a result value output accordingly corresponds to a context vector. Accordingly, a context vector may be generated for each pre-learning environment.

A pre-learning environment context vector storage unit (1510) may store/maintain/update a context vector of a pre-learning environment.

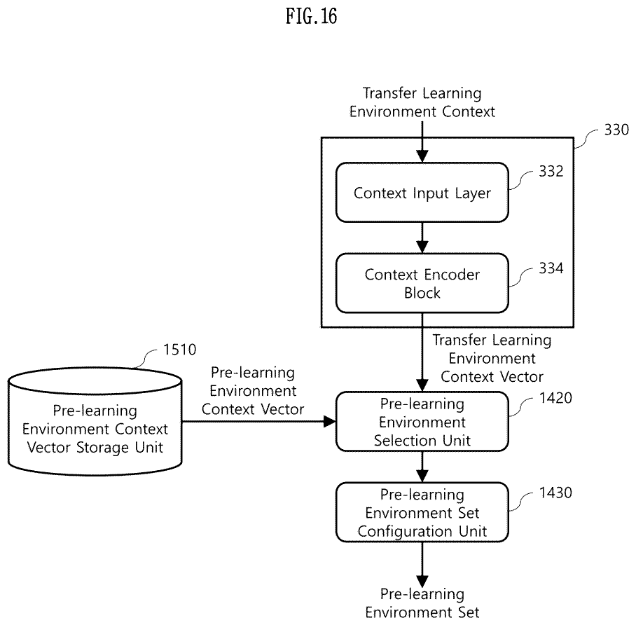

An example of FIG. 16 shows a process of configuring a pre-learning environment set by using a context vector of a pre-learning environment and a transfer learning environment.

A transfer learning environment context may be input to a context input layer (332) of a context module (330) as context information for a transfer learning environment.

A pre-learning environment context vector storage unit (1510) stores a context vector for a pre-learning environment generated according to an example of FIG. 15, and may provide it to a pre-learning environment selection unit (1420).

A context module (330) corresponds to the same context module as a context module used to generate a context vector stored in a pre-learning environment context vector storage unit (1510), and may receive transfer learning environment context information to output a context vector for a transfer learning environment.

A pre-learning environment selection unit (1420) may compare a context vector of an input pre-learning environment with a context vector of a transfer learning environment to select a similar pre-learning environment. When comparing context vectors, for example, an Euclidean distance or a cosine function may be used. As an example, there are 100 pre-learning environments, and 10 pre-learning environments that are most similar to a transfer learning environment may be selected. Specifically, an Euclidean distance value between a transfer learning environment context vector and a context vector of 100 pre-learning environments may be calculated. As a result, 10 pre-learning environments corresponding to 10 context vectors with the smallest distance value may be selected.

A pre-learning environment set configuration unit (1430) may configure/output a pre-learning environment set by collecting pre-learning environments selected in a pre-learning environment selection unit (1420).

Accordingly, a pre-learning environment set newly configured according to a transfer learning environment may be obtained. Pre-learning as described above may be performed based on this pre-learning environment set, and transfer learning based on a transfer learning environment may be performed by reusing a pre-learned model.

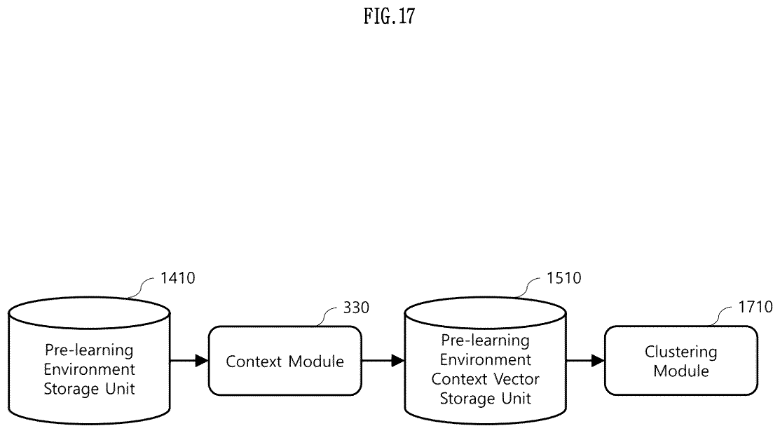

An example of FIG. 17 shows a process of configuring a more subdivided pre-learning environment set by using a context vector of a pre-learning environment and clustering.

A pre-learning environment storage unit (1410) may store/maintain/update the learning environments of a pre-learning environment set as described above.

A context module (330) corresponds to a context module included in a pre-learning model learned by using a learning environment set stored in a pre-learning environment storage unit (1410), and may output a context vector for a pre-learning environment. Output pre-learning environment context vectors may be stored/maintained/updated in a pre-learning environment context vector storage unit (1510).

A clustering module (1710) may perform clustering by using a pre-learning environment context vector. K-means, Fuzzy K-Means, K-Medoids, Hierarchical Clustering, DBScan, HDBScan, etc. may be used as an example of an algorithm used in a clustering module, but a scope of the present disclosure is not limited by a specific example, and a various clustering techniques may be applied.

Each cluster generated through a clustering process may correspond to a more subdivided pre-learning environment of a pre-learning environment storage unit (1410). In other words, each cluster may correspond to a subset of a pre-learning environment set stored in a pre-learning environment storage unit (1410). For example, one pre-learning environment may be included in only one cluster, or may be included in a plurality of clusters. The number and contents of pre-learning environments included in each cluster may be different.

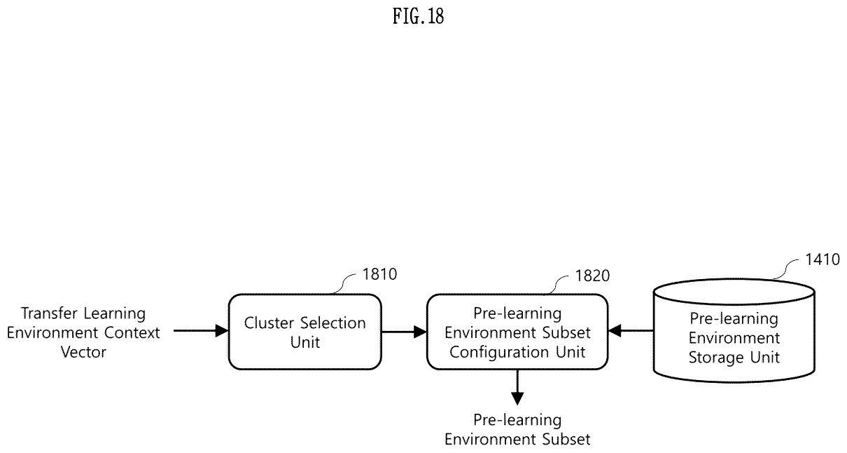

An example of FIG. 18 shows a method for configuring a pre-learning environment set similar to a transfer learning environment by using a context vector of a transfer learning environment and a pre-learning environment cluster generated as described above.

A transfer learning environment context vector corresponds to a context vector extracted from the context information of a transfer learning environment by using a context module (330) learned by using a pre-learning environment set.

A cluster selection unit (1810) may select a pre-learning environment cluster that is most similar to a transfer learning environment context vector. As an example, among pre-learning environment clusters, pre-learning environment context vectors belonging to each cluster may be collected to generate an average vector for each of the 10 clusters. In other words, each average vector corresponds to a value representing each cluster. A Euclidean distance value between a pre-learning environment context vector and 10 average context vectors may be calculated. Accordingly, a cluster with the smallest distance value may be selected.

A pre-learning environment subset configuration unit (1820) may configure a pre-learning environment subset by collecting learning environments included in a cluster selected in a cluster selection unit (1810). A pre-learning environment subset may include pre-learning environments similar to a transfer learning environment among the pre-learning environments of a pre-learning environment storage unit (1410). Pre-learning may be performed as described above by using a pre-learning environment subset, and transfer learning may be performed by using a transfer learning environment.

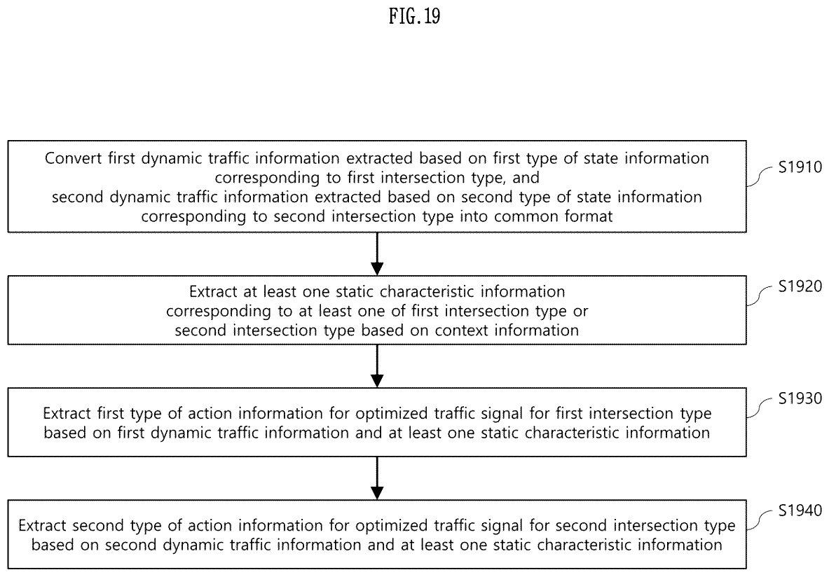

FIG. 19 is a diagram for describing an example of a pre-learning method for traffic signal optimization according to the present disclosure.

In S1910, a device corresponding to an agent (100) or a device corresponding to an agent (110) performing pre-learning may convert first dynamic traffic information extracted based on a first type of state information corresponding to a first intersection type input through a state input layer (312) of a state input module (3100) and second dynamic traffic information extracted based on a second type of state information corresponding to a second intersection type input through a state input layer (312) through a state encoder block (310) into a common format.

Here, a dimension of a first type of state information and a dimension of a second type of state information may be different. In this case, a dimension of first dynamic traffic information and a dimension of second dynamic traffic information converted into a common format may be the same.

In S1920, a device corresponding to an agent (100) or a device corresponding to an agent (110) performing pre-learning may extract at least one static characteristic information corresponding to at least one of a first intersection type or the second intersection type based on context information through a context module (330).

Here, first static characteristic information for a first intersection type and second static characteristic information for a second intersection type may be different information having the same format (i.e., a plurality of individual static characteristic information). Alternatively, first static characteristic information for a first intersection type and second static characteristic information for a second intersection type may be the same information (i.e., one common static characteristic information).

In S1930, a device corresponding to an agent (100) or a device corresponding to an agent (110) performing pre-learning may output a first type of action information on an optimized traffic signal for a first intersection type based on first dynamic traffic information and at least one static characteristic information through a processing module (330) and an action output module (340).

In S1940, a device corresponding to an agent (100) or a device corresponding to an agent (110) performing pre-learning may output a second type of action information on an optimized traffic signal for a second intersection type based on second dynamic traffic information and at least one static characteristic information through a processing module (330) and an action output module (340).

Here, a dimension of a first type of action information output from an action layer (328) and an output dimension of a second type of action information output from an action layer (328) may be the same. And, a dimension of a first action generated based on a first type of action information in an action output layer (340) and a dimension of a second action generated based on a second type of action information in an action output layer (340) may be different.

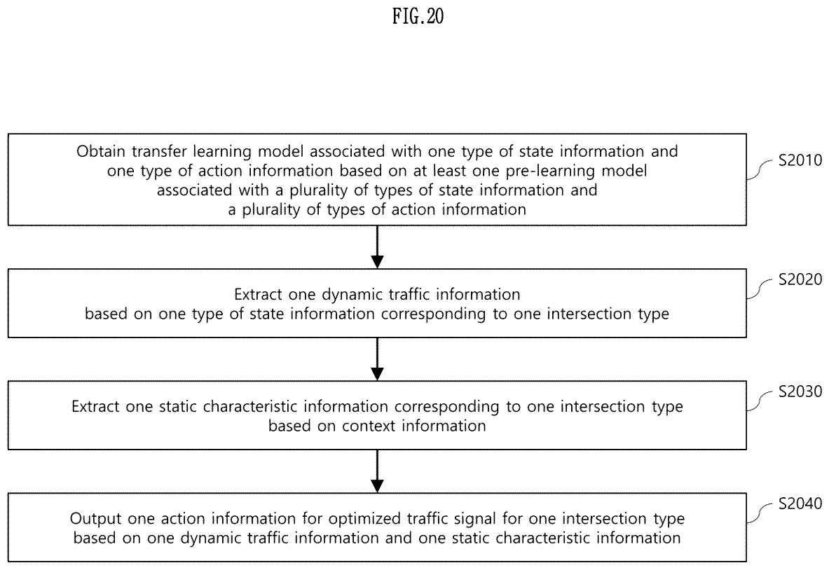

FIG. 20 is a diagram for describing an example of a transfer learning method for traffic signal optimization according to the present disclosure.

In S2010, a device corresponding to an agent (100) or a device corresponding to an agent (120) performing transfer learning may obtain a transfer learning model associated with one type of state information and one type of action information based on at least one pre-learning model associated with a plurality of types of state information and a plurality of types of action information.

Here, the one type of state information associated with a transfer learning model may or may not be included in a plurality of types of state information associated with a pre-learning model. In addition, one type of action information associated with a transfer learning model may or may not be included in a plurality of types of action information associated with a pre-learning model. In other words, any one of a state information type or an action information type associated with a transfer learning model may be included in a plurality of state information types and a plurality of action information types associated with at least one pre-learning model, or neither of them may be included, or both may be included.

For example, when both a state information type or an action information type associated with a transfer learning model are included in a plurality of state information types and a plurality of action information types associated with at least one pre-learning model, a transfer learning model may be obtained as one pre-learning model learned based on a pre-learning environment set having a characteristic corresponding to a transfer learning environment among at least one pre-learning model.

Alternatively, when either or both of a state information type or an action information type associated with a transfer learning model are not included in a plurality of state information types and a plurality of action information types associated with at least one pre-learning model, a transfer learning model may be obtained through pre-learning based on a new pre-learning environment set. For example, a new pre-learning environment set may be included in one cluster selected based on a context vector of a transfer learning environment among a plurality of pre-learning environment clusters.

In S2020, a device corresponding to an agent (100) or a device corresponding to an agent (120) performing transfer learning may extract one dynamic traffic information based on one type of state information corresponding to one intersection type through a state input module (310).

In S2030, a device corresponding to an agent (100) or a device corresponding to an agent (120) performing transfer learning may extract one static characteristic information corresponding to one intersection type based on context information through a context module (330).

In S2040, based on one dynamic traffic information and the one static characteristic information, one action information on an optimized traffic signal for one intersection type may be output through a processing module (320) and an action output module (340).

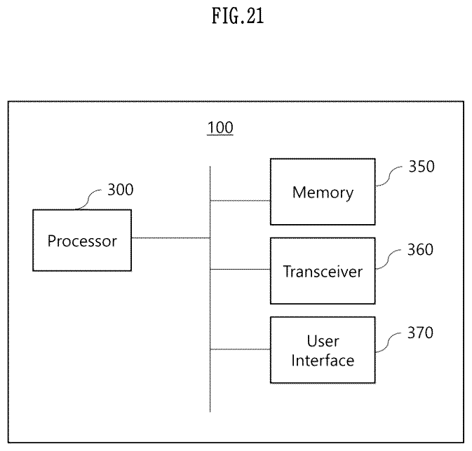

FIG. 21 is a block diagram of a device according to an embodiment of the present disclosure.

A device (100) may correspond to an agent (100) of FIG. 1. Specifically, a device (100) may correspond to an agent (110) involved in pre-learning of FIG. 2 or an agent (120) involved in transfer learning.

A device (100) may include at least one processor (300), at least one memory (350), at least one transceiver (360), at least one user interface (370), etc. A memory (350) may be included in a processor (300) or may be configured separately. A memory (350) may store an instruction that causes a device (100) to perform an operation when executed by a processor (300). A transceiver (360) may transmit and/or receive a signal, data, etc. exchanged by a device (100) with another entity. A user interface (370) may receive a user's input for a device (100) or provide the output of a device (100) to a user. Among the components of a device (100), components other than a processor (300) and a memory (350) may not be included in some cases, and other components not shown in FIG. 5 may be included in a device (100).

A processor (300) may be configured to cause a device (100) to perform an operation according to various examples of the present disclosure. Although not shown in FIG. 21, a processor (300) may be configured as a set of modules that perform each function. A module may be configured in a form of hardware and/or software.

For example, a processor (300) may be configured to convert first dynamic traffic information extracted based on a first type of state information corresponding to a first intersection type input through at least one transceiver (360), and second dynamic traffic information extracted based on a second type of state information corresponding to a second intersection type input through at least one transceiver (360) into a common format; extract at least one static characteristic information corresponding to at least one of a first intersection type or a second intersection type based on context information input through at least one transceiver; based on first dynamic traffic information and at least one static characteristic information, output, through at least one transceiver (360), a first type of action information for an optimized traffic signal for a first intersection type; and based on a second dynamic traffic information and at least one static characteristic information, output, through at least one transceiver (360), a second type of action information for an optimized traffic signal for a second intersection type.

Additionally or alternatively, a processor (300) may be configured to obtain a transfer learning model associated with one type of state information and one type of action information based on at least one pre-learning model associated with a plurality of types of state information and a plurality of types of action information; extract one dynamic traffic information based on one type of state information corresponding to one intersection type input through at least one transceiver (360); extract one static characteristic information corresponding to one intersection type based on context information input through at least one transceiver (360); and based on one dynamic traffic information and one static characteristic information, output, through at least one transceiver (360), one action information for an optimized traffic signal for one intersection type.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A pre-learning method for a traffic signal optimization, the pre-learning method comprising:
converting first dynamic traffic information extracted based on a first type of state information corresponding to a first intersection type, and second dynamic traffic information extracted based on a second type of state information corresponding to a second intersection type into a common format;
extracting at least one static characteristic information corresponding to at least one of the first intersection type or the second intersection type based on context information;
based on the first dynamic traffic information and the at least one static characteristic information, outputting a first type of action information for an optimized traffic signal for the first intersection type; and
based on the second dynamic traffic information and the at least one static characteristic information, outputting a second type of action information for an optimized traffic signal for the second intersection type.

2. The pre-learning method of claim 1, wherein a dimension of the first type of state information and a dimension of the second type of state information are different.

3. The pre-learning method of claim 2, wherein a dimension of the first dynamic traffic information and a dimension of the second dynamic traffic information converted into the common format are the same.

4. The pre-learning method of claim 1, wherein the state information is defined as a vector of a length which is based on a combination of state information elements.

5. The pre-learning method of claim 4, wherein the state information elements include at least one of a number of intersection lanes, a number of vehicles, a speed, or a traffic light state.

6. The pre-learning method of claim 1, wherein the context information element includes at least one of a layout of an intersection, a position of a traffic light, or a road configuration.

7. The pre-learning method of claim 1, wherein first static characteristic information for the first intersection type and second static characteristic information for the second intersection type are different information having a same format.

8. The pre-learning method of claim 1, wherein first static characteristic information for the first intersection type and second static characteristic information for the second intersection type are same information.

9. The pre-learning method of claim 1, wherein an output dimension of the first type of action information and an output dimension of the second type of action information are the same.

10. The pre-learning method of claim 9, wherein a dimension of a first action generated based on the first type of action information, and a dimension of a second action generated based on the second type of action information are different.

11. The pre-learning method of claim 10, wherein:
the first action includes a time distribution ratio for a first number of signal indications of the first intersection type, and
the second action includes a time distribution ratio for a second number of signal indications of the second intersection type.

12. The pre-learning method of claim 1, wherein:
based on a backpropagation of a first action generated in response to the first type of action information, a parameter of at least one of a first type of action output layer, a first type of action decoder block, a processing module, a context module, a first type of encoder block, or a first type of state input layer is updated, and
based on a backpropagation of a second action generated in response to the second type of action information, a parameter of at least one of a second type of action output layer, a second type of action decoder block, the processing module, the context module, a second type of encoder block, or a second type of state input layer is updated.

13. A device for performing pre-learning for a traffic signal optimization, the device comprising:
at least one transceiver;
at least one processor; and
at least one memory operably connected to the at least one processor, and storing an instruction to make the device perform an operation when executed by the at least one processor,
wherein the processor is configured to:
convert first dynamic traffic information extracted based on a first type of state information corresponding to a first intersection type input through the at least one transceiver, and second dynamic traffic information extracted based on a second type of state information corresponding to a second intersection type input through the at least one transceiver into a common format;
extract at least one static characteristic information corresponding to at least one of the first intersection type or the second intersection type based on context information input through the at least one transceiver;
based on the first dynamic traffic information and the at least one static characteristic information, output, through the at least one transceiver, a first type of action information for an optimized traffic signal for the first intersection type; and
based on the second dynamic traffic information and the at least one static characteristic information, output, through the at least one transceiver, a second type of action information for an optimized traffic signal for the second intersection type.

14. A transfer learning method for a traffic signal optimization, the transfer learning method comprising:
based on at least one pre-learning model associated with a plurality of types of state information and a plurality of types of action information, obtaining a transfer learning model associated with one type of state information and one type of action information;
extracting one dynamic traffic information based on the one type of state information corresponding to one intersection type;
extracting one static characteristic information corresponding to the one intersection type based on context information; and
based on the one dynamic traffic information and the one static characteristic information, outputting one action information for an optimized traffic signal for the one intersection type.

15. The transfer learning method of claim 14, wherein:
the one type of state information associated with the transfer learning model is or is not included in the plurality of types of state information associated with the at least one pre-learning model, and
the one type of action information associated with the transfer learning model is or is not included in the plurality of types of action information associated with the at least one pre-learning model.

16. The transfer learning method of claim 14, wherein:
based on a backpropagation of an action generated in response to the one type of action information, a parameter of at least one of one type of action output layer, one type of action decoder block, a processing module, a context module, one type of encoder block, or one type of state input layer is updated.

17. The transfer learning method of claim 14, wherein the transfer learning model, among the at least one pre-learning model, corresponds to one pre-learning model learned based on a set of pre-learning environments having a characteristic corresponding to a transfer learning environment.

18. The transfer learning method of claim 14, wherein:
when a pre-learning model learned based on a set of pre-learning environments having a characteristic corresponding to a transfer learning environment among the at least one pre-learning model is not included, the transfer learning model is obtained through a pre-learning based on a new set of pre-learning environments.

19. The transfer learning method of claim 18, wherein the new set of pre-learning environments is included in one cluster selected based on a context vector of the transfer learning environment among a plurality of pre-learning environment clusters.
